(19) United States
(12) Patent Application Publication
(10) Pub. No.: US 2023/0361975 A1
(43) Pub. Date: Nov. 9, 2023

(54) METHOD OF SHARING SRS RESOURCES BETWEEN SRS RESOURCE SETS OF DIFFERENT USAGES, AND CORRESPONDING UE

(71) Applicant: NTT DOCOMO, INC., Tokyo (JP)

(72) Inventors: Nadisanka Rupasinghe, Tokyo (JP); Yuki Matsumura, Tokyo (JP)

(73) Assignee: NTT DOCOMO, INC., Tokyo (JP)

(21) Appl. No.: 18/042,148

(22) PCT Filed: Aug. 17, 2021
(86) PCT No.: PCT/US2021/046326

§ 371 Date: Feb. 17, 2023

Related U.S. Application Data
(60) Provisional application No. 63/067,238, filed on Aug. 18, 2020.

(51) Int. Cl. H04L 5/00

(52) U.S. Cl. CPC H04L 5/0076; H04L 5/0051; H04L 5/0091

(57) ABSTRACT

A user equipment (UE) is disclosed that includes a receiver that receives a parameter and a processer that, based on the parameter, configures Sounding Reference Signal (SRS) resources with a first SRS resource set and a second SRS resource set. The UE further includes a transmitter that transmits one or more SRSs using the SRS resources. In other aspects, a method and a wireless communication system are also disclosed.

### CROSS-REFERENCE TO RELATED APPLICATIONS

This application claims priority to United States Provisional Pat. Application Serial No. 63/067,238, titled “A METHOD OF SHARING SRS RESOURCES BETWEEN SRS RESOURCE SETS OF DIFFERENT USAGES,” which was filed on Aug. 18, 2020, and is incorporated herein by reference in its entirety.

### TECHNICAL FIELD

One or more embodiments disclosed herein relate to a method of sounding reference signal (SRS)-assisted sub-band configuration for Type I/II channel state information (CSI) in a wireless communication system.

### BACKGROUND

In 5G new radio (NR) technologies, new requirements are being identified for further enhancing SRS transmission. New items in Rel. 17 relate to, for example, NR Multiple-Input-Multiple-Output (MIMO).

In the new studies being conducted, enhancement of the SRS is targeted for both Frequency Range (FR) 1 and FR2. In particular, study is under way to identify and specify enhancements on aperiodic SRS triggering to facilitate more flexible triggering and/or Downlink Control Information (DCI) overhead/usage reduction.

Additionally, study is under way to specify SRS switching for up to 8 antennas (e.g., xTyR, x = {1, 2, 4} and y = {6, 8}). Further, studies are evaluating and, if needed, specifying the following mechanism(s) to enhance SRS capacity and/or coverage: SRS time bundling, increased SRS repetition, partial sounding across frequency.

### CITATION LIST

### Non-Patent Reference

[Non-Patent Reference 1] 3GPP RP 193133, “New WID: Further enhancements on MIMO for NR”, Dec., 2019
[Non-Patent Reference 2] 3GPP TS 38.331, “NR; Radio Resource Control; Protocol specification (Release 15)”
[Non-Patent Reference 3] 3GPP TS 38.214, “NR; Physical procedure for data (Release 16)”
[Non-Patent Reference 4] Erik Dahlman, Stefan Parkvall, Johan Skold. “5G NR: The Next Generation Wireless Access Technology”

### SUMMARY

One or more embodiments provide a method of SRS switching extended to support up to 8 antenna ports in various configurations.

According to one or more embodiments, a user equipment (UE) includes a receiver that receives a parameter, a processer that, based on the parameter, configures Sounding Reference Signal (SRS) resources with a first SRS resource set and a second SRS resource set, and a transmitter that transmits one or more SRSs using the SRS resources.

In one aspect of the UE, the first SRS resource set has a first usage and the second SRS resource set has a second usage, and the first SRS resource set and the second SRS resource set overlap.

In one aspect of the UE, the parameter indicates at least one of ‘codebook’ and ‘antennaswitching’ .

In one aspect of the UE, each of the first SRS resource set and the second SRS resource set has one of 1, 2, and 4 antenna ports.

In one aspect of the UE, the receiver receives downlink control information (DCI) triggering usage of at least one of the first SRS resource set and the second SRS resource set.

In one aspect of the UE, each of the SRS resources has a unique antenna port.

In one aspect of the UE, the parameter indicates a number n of overlapping SRS resources between the first SRS resource set and the second SRS resource set.

In one aspect of the UE, each of the SRS resources has a unique antenna port.

In one aspect of the UE, the transmitter transmits a first SRS using a SRS resource from the first SRS resource set and a second SRS using a second SRS resource from the second SRS resource set, and wherein the first SRS and the second SRS are associated to an antenna port pair.

In one aspect of the UE, the receiver receives a resource indicator by downlink control information indicating an antenna port for Physical Uplink Shared Channel (PUSCH) transmission.

In one aspect of the UE, n the parameter is higher layer signaled.

According to one or more embodiments, a method for a user equipment (UE) includes receiving a parameter, configuring, based on the parameter, Sounding Reference Signal (SRS) resources with a first SRS resource set and a second SRS resource set, and transmitting one or more SRSs using the SRS resources.

According to one or more embodiments, a wireless communication system includes a user equipment (UE) that has a receiver that receives a parameter, a processer that, based on the parameter, configures Sounding Reference Signal (SRS) resources with a first SRS resource set and a second SRS resource set, and a transmitter that transmits one or more SRSs using the SRS resources. The system also includes a base station (BS) having a second receiver that receives the one or more SRSs.

Other embodiments and advantages of the present invention will be recognized from the description and figures.

### BRIEF DESCRIPTION OF THE DRAWINGS

FIG. 1 shows an example SRS-ResourceSet Information Element.

FIG. 2 shows an example SRS-Resource Information Element..

FIG. 3 shows an example of two SRS resources assigned to different antenna port pairs.

FIG. 4 shows an example of Multi-port SRS resources for spatial filter selection.

FIG. 5 shows an example of SRS Resource Set(s) reuse for different usages for nTnR.

FIG. 6 shows an example clarifying overlapping SRS resource(s).

FIG. 7 shows an example of SRS Resource Set(s) reuse for different usages for 1T2R.

FIG. 8 shows an example of SRS Resource Set(s) reuse for different usages for 1T4R.

FIG. 9 shows an example of SRS Resource Set(s) reuse for different usages for 1T6R.

FIG. 10 shows an example of SRS Resource Set(s) reuse for different usages for 2T4R.

FIG. 11 shows an example of a UE using a port pair for UL PUSCH transmission for 2T4R.

FIG. 12 shows an example of SRS Resource Set(s) reuse for different usages for 2T6R.

FIG. 13 shows an example of a UE using a port pair for UL PUSCH transmission for 2T6R.

FIG. 14 shows an example of SRS Resource Set(s) reuse for different usages for 2T8R.

FIG. 15 shows an example of a UE using a port pair for UL PUSCH transmission for 2T8R.

FIG. 16 shows an example of SRS Resource Set(s) reuse for different usages for 4T6R.

FIG. 17 shows an example of a UE using a port pair for UL PUSCH transmission for 4T6R.

FIG. 18 shows an example of SRS Resource Set(s) reuse for different usages for 4T8R.

FIG. 19 shows an example of a UE using a port pair for UL PUSCH transmission for 4T8R.

FIG. 20 shows an example flowchart of network operations.

FIG. 21 shows an example of SRS Resource Set(s) reuse for different usages and a UE using all 4 ports for PUSCH transmission for 4T4R.

FIG. 22 shows an example of SRS Resource Set(s) reuse for different usages and a UE using 4 ports for PUSCH transmission for 4T6R.

FIG. 23 shows an example of SRS Resource Set(s) reuse for different usages and a UE using 4 ports for PUSCH transmission for 4T6R.

FIG. 24 shows an example of SRS Resource Set(s) reuse for different usages and a UE using 4 ports for PUSCH transmission for 4T8R.

FIG. 25 shows an example of SRS Resource Set(s) reuse for different usages and a UE using 4 ports for PUSCH transmission for 4T8R.

FIG. 26 is a diagram showing a schematic configuration of a BS according to embodiments.

FIG. 27 is a diagram showing a schematic configuration of a UE according to embodiments.

FIG. 28 is a schematic configuration of the UE 10 according to embodiments.

### DETAILED DESCRIPTION

Embodiments of the present invention will be described in detail below with reference to the drawings. Like elements in the various figures are denoted by like reference numerals for consistency.

In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

As discussed above, studies are under way with regard to the enhancement of SRS. In one or more embodiments described herein, SRS overhead may be reduced by reusing SRS resources for multiple SRS usages.

In one or more embodiments, SRS may be configured by RRC using one or more Information Elements (IEs). The SRS-Config IE is used to configure sounding reference signal (SRS) transmissions.

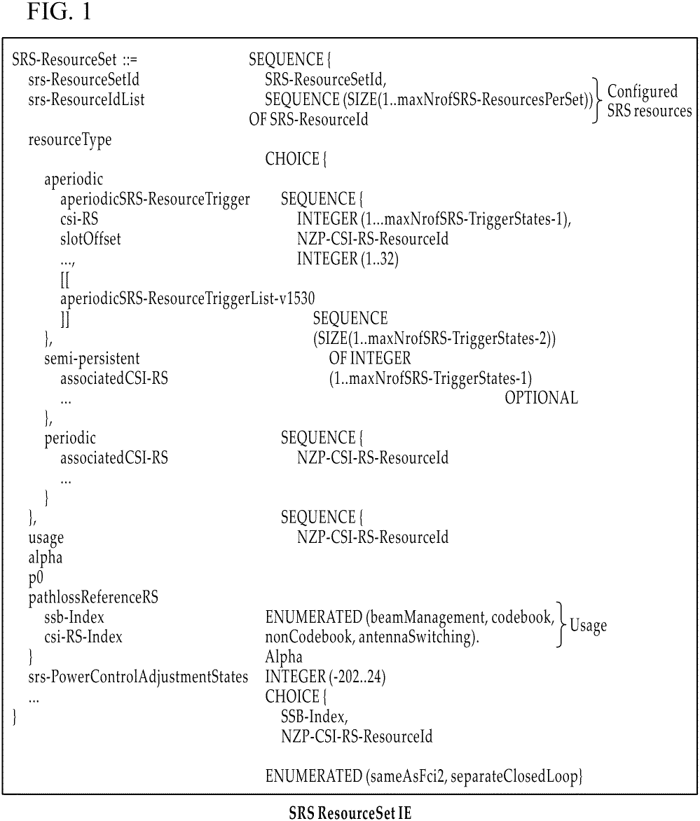

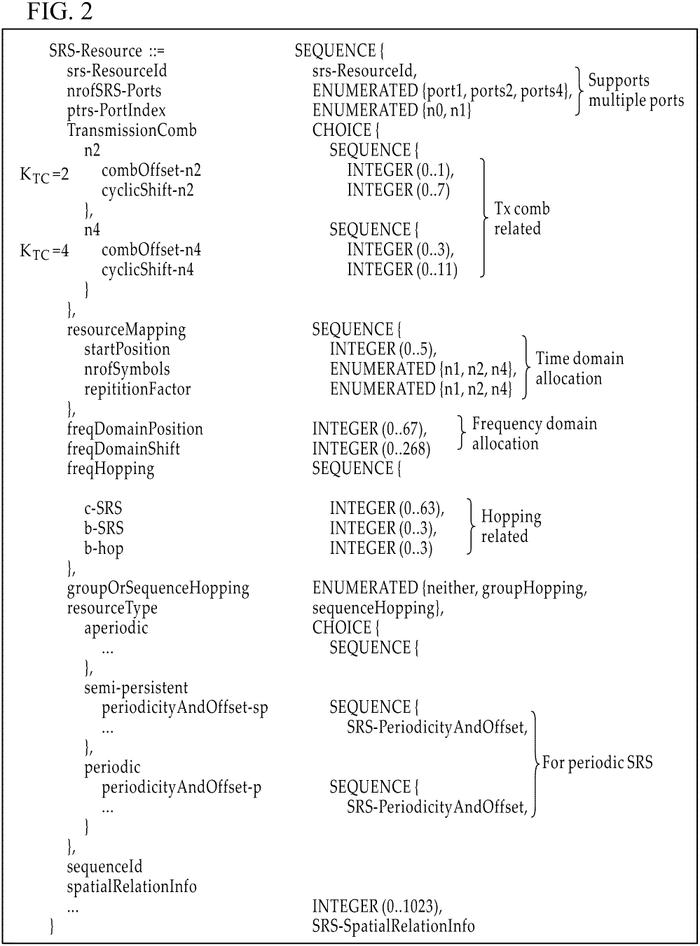

FIG. 1 shows an example of a SRS-ResourceSet IE. FIG. 2 shows an example of a SRS-Resource IE. A list of SRS-ResourceSets and SRS-Resources may be defined in SRS-Config. Each SRS-ResourceSet may be configured with a set of SRS-Resources. Applicability of SRS-ResourceSets may be configured by the parameter ‘usage’ as shown in FIG. 1. When a Physical Uplink Shared CHannel (PUSCH) and SRS are transmitted in the same slot, a User Equipment (UE) may only be configured to transmit SRS after the transmission of the PUSCH and the corresponding Demodulation Reference Signal (DM-RS).

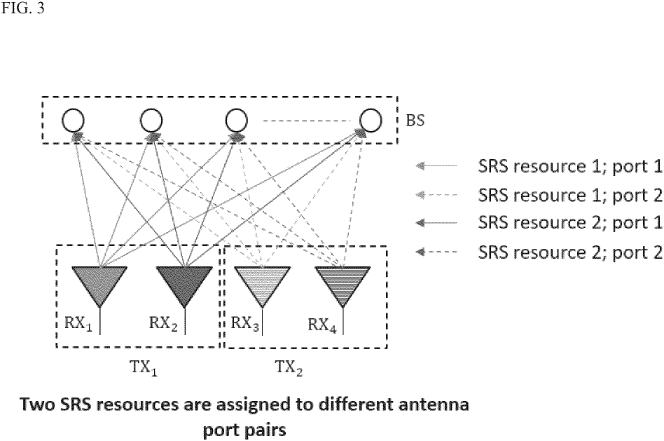

In one or more embodiments, UE sounding for downlink (DL) Channel State Information (CSI) acquisition may relate to a usage set to ‘antennaswitching.’ That is, for sounding the DL channel, SRS resource set(s) with usage set to ‘antennaswitching’ can be considered. A number of ports of a SRS resource in a SRS resource set with usage set to ‘antennaswitching’ is based on available Tx ports at the UE. For example, with reference to FIG. 3, consider a UE transceiver architecture 2T4R (2 Tx ports, 4 Rx ports). Then, for DL CSI acquisition, the UE is configured with 2 SRS resources each with 2-ports (equal to no. of Tx ports). In this scenario shown in FIG. 3, two SRS resources are assigned to different antenna port pairs. For example, TS 38.214 § 6.2.1.2 describes that for 2T4R, up to two SRS resource sets configured with a different value for the higher layer parameter resourceType in SRS-ResourceSet set, where each SRS resource set has two SRS resources transmitted in different symbols, each SRS resource in a given set consisting of two SRS ports, and the SRS port pair of the second resource is associated with a different UE antenna port pair than the SRS port pair of the first resource.

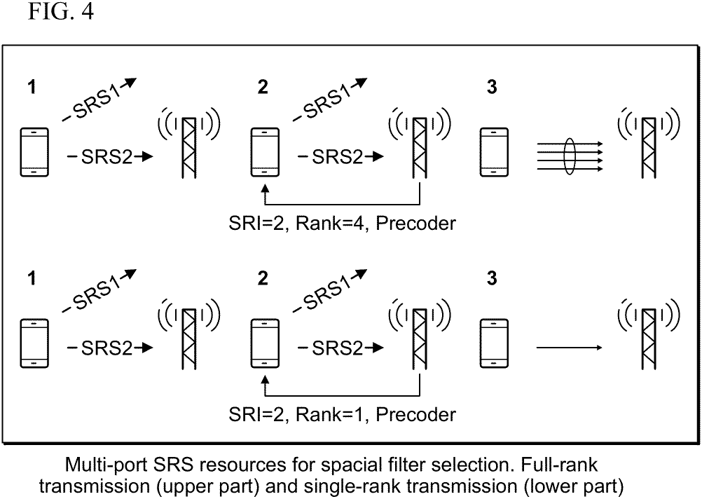

In one or more embodiments, UE channel sounding with SRS may relate to usage set to ‘codebook.’ A SRS resource set consists of maximum 2-SRS resources in Rel. 15 and maximum 4-SRS resources in Rel. 16. In Rel. 15, multiple multi-port SRS resources are used for spatial filter selection. Each SRS resource is associated with a different spatial filter. For example, FIG. 4 shows multi-port SRS resources for spatial filter selection. Full-rank transmission is shown in the upper part of FIG. 4 and single-rank transmission is shown in the lower part of FIG. 4.

In Rel. 16, multiple SRS resources are used for selecting a different number of ports for Mode 2 transmission. For example:
SRS resource #1: 1-port;
SRS resource #2: 2-ports;
SRS resource #3: 4-ports.

An additional DCI bit may be required to select among 3 options. This may also allow for one reserved state.

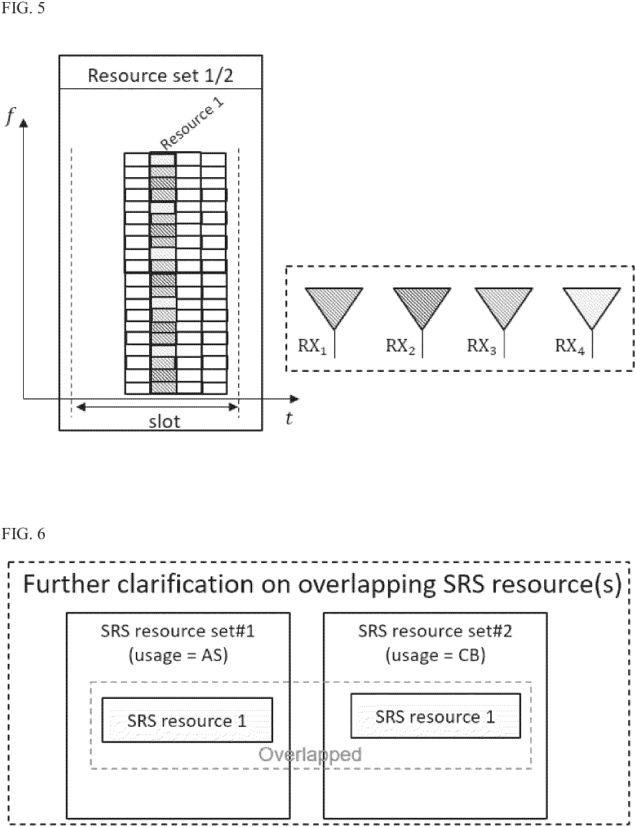

In Example 1, SRS Resource Set(s) Reuse for Different Usages for nTnR are described with reference to FIG. 5 and FIG. 6. SRS resource(s) may be higher layer configured to completely overlap between two SRS resource sets with usage set to ‘codebook’ and ‘antennaswitching,’ respectively. Each SRS resource in a given set has n ∈ {1, 2, 4} port(s). Using a SRS request field of DCI, the Network (NW) triggers either or both SRS resource sets with usage set to ‘codebook’ and ‘antennaswitching.’ A UE transmits SRS resources in both SRS resource sets with each SRS port uniquely associating to an antenna port. Further, using SRS, the NW determines a channel condition and accordingly configures a Transmitted Precoding Matrix Indicator (TPMI) for uplink (UL) PUSCH transmission.

In Example 1 shown by FIGS. 5, 4 port SRS resource is configured overlapping between resource sets with usage ‘codebook’ and ‘antennaswitching.’ Based on the received SRS, the NW determines TPMI for UL PUSCH and indicates that to the UE. In FIG. 5, different colors within a resource represent different ports. Further, resource set 1 usage is set to ‘codebook’ and resource set 2 usage is set to ‘antennaswitching.’ FIG. 6 clarifies an example relationship between overlapping SRS resource(s).

In Example 2, SRS Resource Set(s) Reuse for Different Usages for 1T2R are described with reference to FIG. 7. In one or more embodiments in accordance with Example 2, n overlapping SRS resources are higher layer configured between two SRS resource sets with usage set to ‘codebook’ and ‘antennaswitching,’ respectively. Each SRS resource in a given set has a single port. Using a SRS request field of DCI, the NW triggers either or both SRS resource sets with usage set to ‘codebook’ and ‘antennaswitching.’ The UE transmits SRS resources in both SRS resource sets with each SRS port uniquely associating to an antenna port. Subsequently, using a x-bit(s) SRS resource indicator (SRI), the NW informs UE which antenna port to consider for PUSCH transmission. In Example 2 shown by FIG. 7, n=2 SRS resources are configured overlapping between resource sets with usage ‘codebook’ and ‘antennaswitching.’ Using x=1 bits SRI, the NW indicates which port to consider for UL PUSCH transmission. It is noted that using RRC or MAC CE signaling, it is possible to select a subset of overlapping SRS resources within SRS resource set with usage ‘codebook’, for example using a RRC/MAC CE, only Resource 1 can be selected and hence n=1. Then, no SRI indication takes place. Further, in FIG. 7, SRS resource set 1 usage is set to ‘codebook’ and resource set 2 usage is set to ‘antennaswitching.’

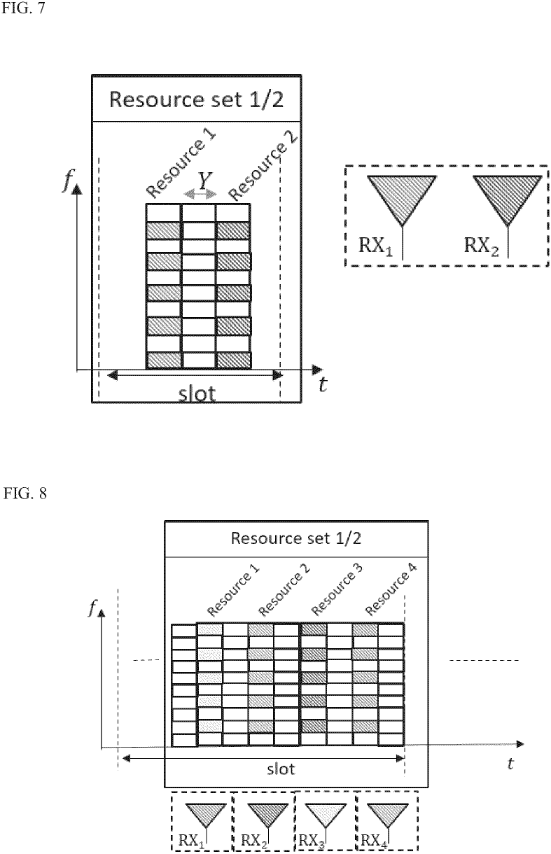

In Example 3, SRS Resource Set(s) Reuse for Different Usages for 1T4R are described with reference to FIG. 8. In one or more embodiments in accordance with Example 3, n overlapping SRS resources are higher layer configured between two SRS resource sets with usage set to ‘codebook’ and ‘antennaswitching,’ respectively. Each SRS resource in a given set has a single port. Using a SRS request field of DCI, the NW triggers either or both SRS resource sets with usage set to ‘codebook’ and ‘antennaswitching.’ The UE transmits SRS resources in both SRS resource sets with each SRS port uniquely associating to an antenna port. Subsequently, using x-bit(s) SRS resource indicator (SRI), NW informs UE which antenna port to consider for PUSCH transmission.

In Example 3 described in FIG. 8, n=4 SRS resources are configured overlapping between resource sets with usage ‘codebook’ and ‘antennaswitching.’ Using x=2 bits SRI, the NW indicates which port to consider for UL PUSCH transmission. It is noted that using RRC or MAC CE signaling, it is possible to select subset of overlapping SRS resources within SRS resource set with usage ‘codebook’, e.g. using RRC/MAC CE, only resource 1 and 2 can be selected and hence n=2. Then x=1 bit is enough for port selection for PUSCH transmission. Further, in FIG. 8, resource set 1 usage is set to ‘codebook’ and resource set 2 usage is set to ‘antennaswitching.’

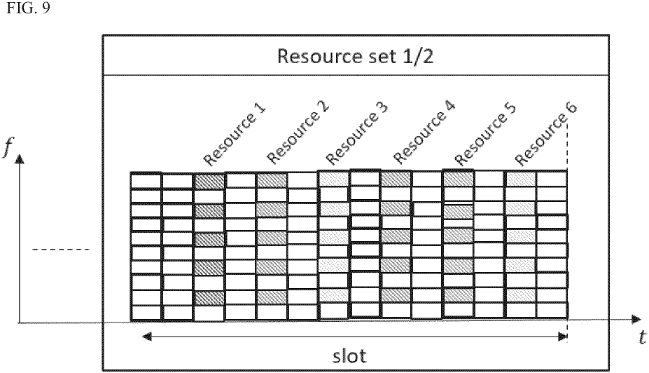

In Example 4, SRS Resource Set(s) Reuse for Different Usages for 1T6R are described with reference to FIG. 9. In one or more embodiments in accordance with Example 4, n overlapping SRS resources are higher layer configured between two SRS resource sets with usage set to ‘codebook’ and ‘antennaswitching,’ respectively. Each SRS resource in a given set has a single port. Using SRS request field of DCI, the NW triggers either or both SRS resource sets with usage set to ‘codebook’ and ‘antennaswitching.’ The UE transmits SRS resources in both SRS resource sets with each SRS port uniquely associating to an antenna port. Subsequently, using x-bit(s) SRS resource indicator (SRI), the NW informs the UE which antenna port to consider for PUSCH transmission.

In Example 4 described in FIG. 9, n=6 SRS resources are configured overlapping between resource sets with usage ‘codebook’ and ‘antennaswitching.’ Using x=3 bits SRI, the NW indicates which port to consider for UL PUSCH transmission. It is noted that using RRC or MAC CE signaling, it is possible to select subset of overlapping SRS resources within SRS resource set with usage ‘codebook’, for example using RRC/MAC CE, only resource 1 and 2 can be selected and hence n=2. Then x=1 bit is enough for port selection. Further, in FIG. 9, resource set 1 usage is set to ‘codebook’ and resource set 2 usage is set to ‘antennaswitching.’

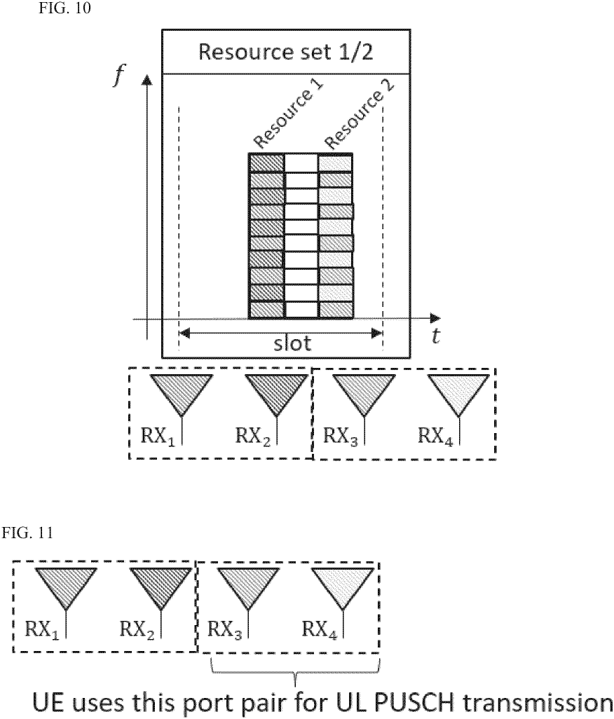

In Example 5, SRS Resource Set(s) Reuse for Different Usages for 2T4R are described with reference to FIG. 10 and FIG. 11. In one or more embodiments in accordance with Example 5, n overlapping SRS resources are higher layer configured in two SRS resource sets with usage set to ‘codebook’ and ‘antennaswitching,’ respectively. Each SRS resource in a given set consists of two ports. Using a SRS request field of DCI, the NW triggers either or both SRS resource sets with usage set to ‘codebook’ and ‘antennaswitching.’ The UE transmits SRS resources in both SRS resource sets with each SRS resource uniquely associating to an antenna port pair. Subsequently, using a x-bit(s) SRS resource indicator (SRI), the NW informs the UE which antenna ports to consider for PUSCH transmission.

In Example 5 described in FIG. 10, n=2 SRS resources are configured overlapping between resource sets with usage ‘codebook’ and ‘antennaswitching.’ Using x=1 bits SRI, the NW indicates UL PUSCH transmission ports, for example x=1 -> ports associated with 2^{nd} SRS resource (see FIG. 11). It is noted that using RRC or MAC CE signaling, it is possible to select a subset of overlapping SRS resources within SRS resource set with usage ‘codebook’, for example using RRC/MAC CE, only resource 1 can be selected and hence n=1. Then, no SRI indication takes place. Further, in FIG. 10, resource set 1 usage is set to ‘codebook’ and resource set 2 usage is set to ‘antennaswitching.’ FIG. 11 shows an example of a UE using a port pair for UL PUSCH transmission.

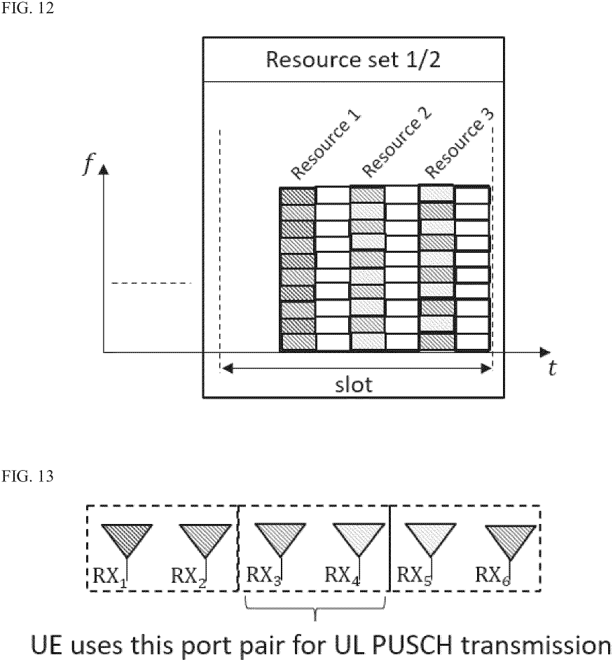

In Example 6, SRS Resource Set(s) Reuse for Different Usages for 2T6R are described with reference to FIG. 12 and FIG. 13. In one or more embodiments in accordance with Example 6, n overlapping SRS resources are higher layer configured in two SRS resource sets with usage set to ‘codebook’ and ‘antennaswitching,’ respectively. Each SRS resource in a given set consists of two ports. Using a SRS request field of DCI, the NW triggers either or both SRS resource sets with usage set to ‘codebook’ and ‘antennaswitching.’ The UE transmits SRS resources in both SRS resource sets with each SRS resource uniquely associating to antenna port pair. Subsequently, using a x-bit(s) SRS resource indicator (SRI), the NW informs the UE which antenna ports to consider for PUSCH transmission.

In Example 6 described in FIG. 12, n=3 SRS resources are configured overlapping between resource sets with usage ‘codebook’ and ‘antennaswitching.’ Using x=2 bits SRI, the NW indicates UL PUSCH transmission ports, for example x=10 -> ports associated with 2^{nd} SRS resource (see FIG. 13). It is noted that using RRC or MAC CE signaling, it is possible to select subset of overlapping SRS resources within SRS resource set with usage ‘codebook,’ for example using RRC/MAC CE, only resource 1 and 2 can be selected and hence n=2. Then x=1 bit is enough for selecting transmitting ports. Further, in FIG. 12, resource set 1 usage is set to ‘codebook’ and resource set 2 usage is set to ’antennaswitching.’FIG. 13 shows an example of a UE using a port pair for UL PUSCH transmission.

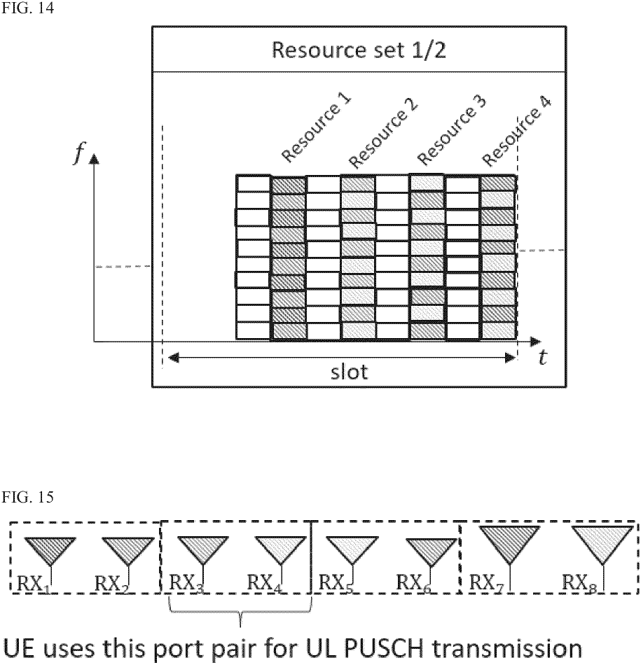

In Example 7, SRS Resource Set(s) Reuse for Different Usages for 2T8R are described with reference to FIG. 14 and FIG. 15. In one or more embodiments in accordance with Example 7, n overlapping SRS resources are higher layer configured in two SRS resource sets with usage set to ‘codebook’ and ‘antennaswitching’, respectively. Each SRS resource in a given set consists of two ports. Using a SRS request field of DCI, the NW triggers either or both SRS resource sets with usage set to ‘codebook’ and ‘antennaswitching.’ The UE transmits SRS resources in both SRS resource sets with each SRS resource uniquely associating to an antenna port pair. Subsequently, using x-bit(s) SRS resource indicator (SRI), the NW informs the UE which antenna ports to consider for PUSCH transmission.

In Example 7 described in FIG. 14, n=4 SRS resources are configured overlapping between resource sets with usage ‘codebook’ and ‘antennaswitching.’ Using x=2 bits SRI, the NW indicates UL PUSCH transmission ports, for example x=10 -> ports associated with 2^{nd} SRS resource (see FIG. 15). It is noted that using RRC or MAC CE signaling, it is possible to select subset of overlapping SRS resources within SRS resource set with usage ‘codebook’, for example using RRC/MAC CE, only resource 1 and 2 can be selected and hence n=2. Then x=1 bit is enough for selecting PUSCH transmitting ports. Further, in FIG. 14, resource set 1 usage is set to ‘codebook’ and resource set 2 usage is set to ’antennaswitching.’FIG. 15 shows an example of a UE using a port pair for UL PUSCH transmission.

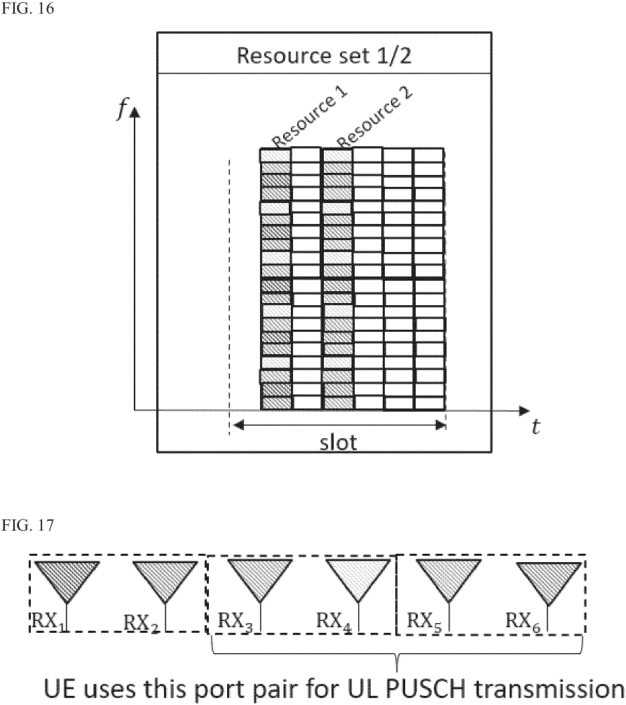

In Example 8, SRS Resource Set(s) Reuse for Different Usages for 4T6R are described with reference to FIG. 16 and FIG. 17. In one or more embodiments in accordance with Example 8, n overlapping SRS resources are higher layer configured in two SRS resource sets with usage set to ‘codebook’ and ‘antennaswitching’, respectively. Each SRS resource in a given set consists of 4 ports. Using a SRS request field of DCI, the NW triggers either or both SRS resource sets with usage set to ‘codebook’ and ‘antennaswitching.’ The UE transmits SRS resources in both SRS resource sets with each SRS resource uniquely associating to 4 antenna ports. Subsequently, using x-bit SRS resource indicator (SRI), the NW informs the UE which antenna ports to consider for PUSCH transmission.

In Example 8 described in FIG. 16, n=2 SRS resources are configured overlapping between resource sets with usage ‘codebook’ and ‘antennaswitching.’ Using x=1 bits SRI, the NW indicates UL PUSCH transmission ports, for example x=1 -> ports associated with 2^{nd} SRS resource (see FIG. 17). It is noted that using RRC or MAC CE signaling, it is possible to select subset of overlapping SRS resources within SRS resource set with usage ‘codebook,’ for example using RRC/MAC CE, only resource 1 can be selected and hence n=1. Then, no SRI indication takes place. Further, in FIG. 16, resource set 1 usage is set to ‘codebook’ and resource set 2 usage is set to ‘antennaswitching.’ FIG. 17 shows an example of a UE using a port pair for UL PUSCH transmission.

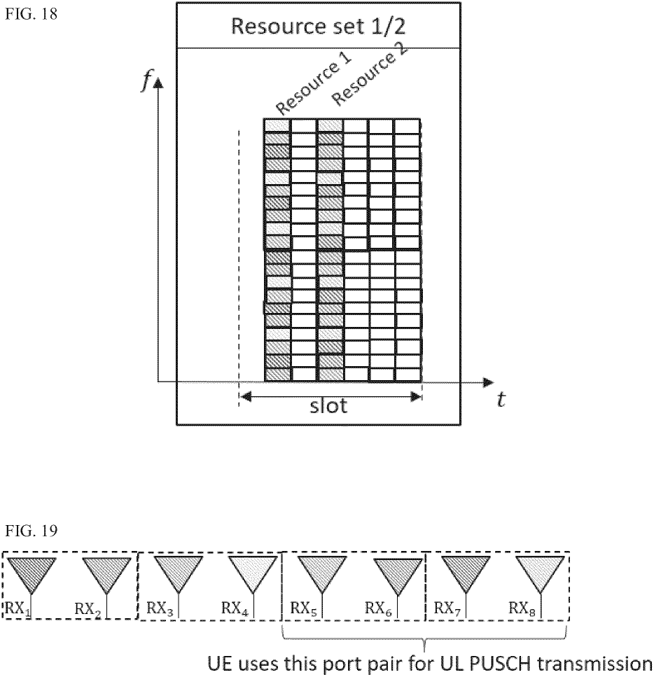

In Example 9, SRS Resource Set(s) Reuse for Different Usages for 4T8R are described with reference to FIG. 18 and FIG. 19. In one or more embodiments in accordance with Example 9, n overlapping SRS resources are higher layer configured in two SRS resource sets with usage set to ‘codebook’ and ‘antennaswitching,’ respectively. Each SRS resource in a given set consists of 4 ports. Using a SRS request field of DCI, the NW triggers either or both SRS resource sets with usage set to ‘codebook’ and ‘antennaswitching.’ The UE transmits SRS resources in both SRS resource sets with each SRS resource uniquely associating to 4 antenna ports. Subsequently, using a x-bit SRS resource indicator (SRI), the NW informs the UE which antenna ports to consider for PUSCH transmission.

In Example 9 described in FIG. 18, n=2 SRS resources are configured overlapping between resource sets with usage ‘codebook’ and ‘antennaswitching.’ Using x=1 bits SRI, the NW indicates UL PUSCH transmission ports, for example x=1 -> ports associated with 2^{nd} SRS resource (see FIG. 19). It is noted that using RRC or MAC CE signaling, it is possible to select subset of overlapping SRS resources within SRS resource set with usage ‘codebook,’ for example using RRC/MAC CE, only resource 1 can be selected and hence n=1. Then, no SRI indication takes place. Further, in FIG. 18, resource set 1 usage is set to ‘codebook’ and resource set 2 usage is set to ‘antennaswitching.’ FIG. 19 shows an example of a UE using a port pair for UL PUSCH transmission.

One or more embodiments in accordance with one or more of Examples 1 through 9 exhibit one or more of the following advantages. Specifically, by sharing SRS resources between different usages, associated SRS overhead can be reduced. Additionally, if a number of Tx chains are smaller than Rx chains at the UE, the NW can select port(s) associated with better channel conditions for UL PUSCH transmission.

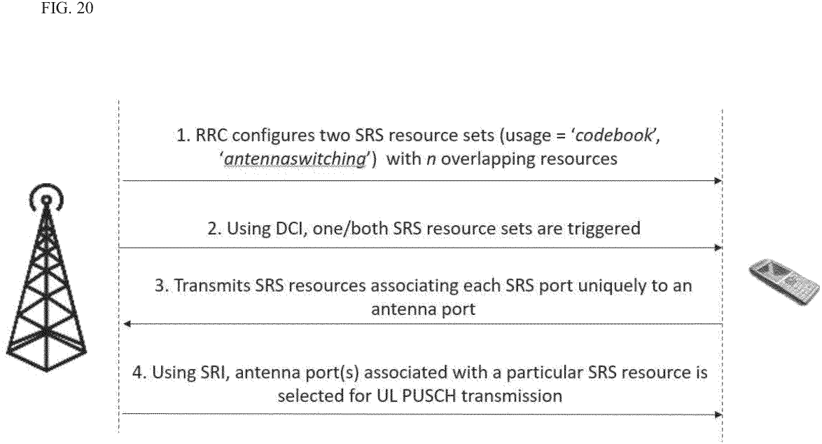

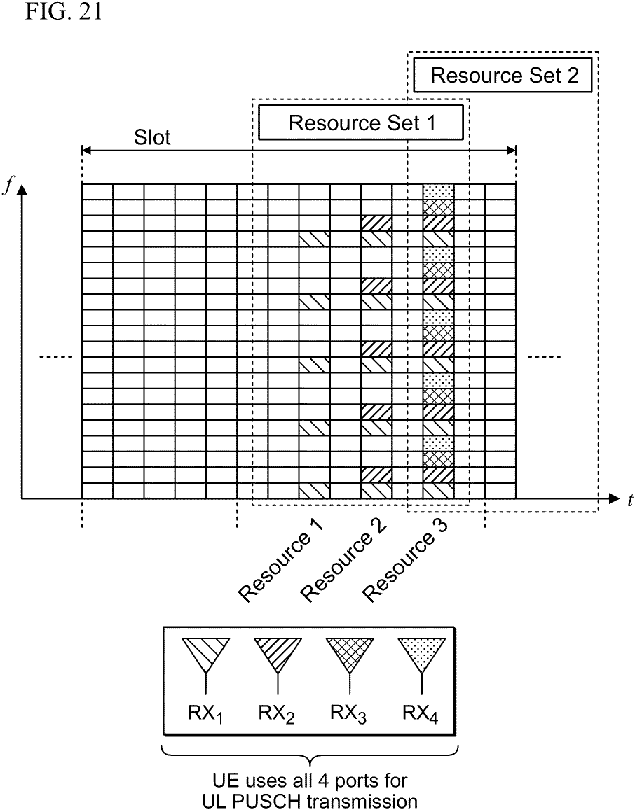

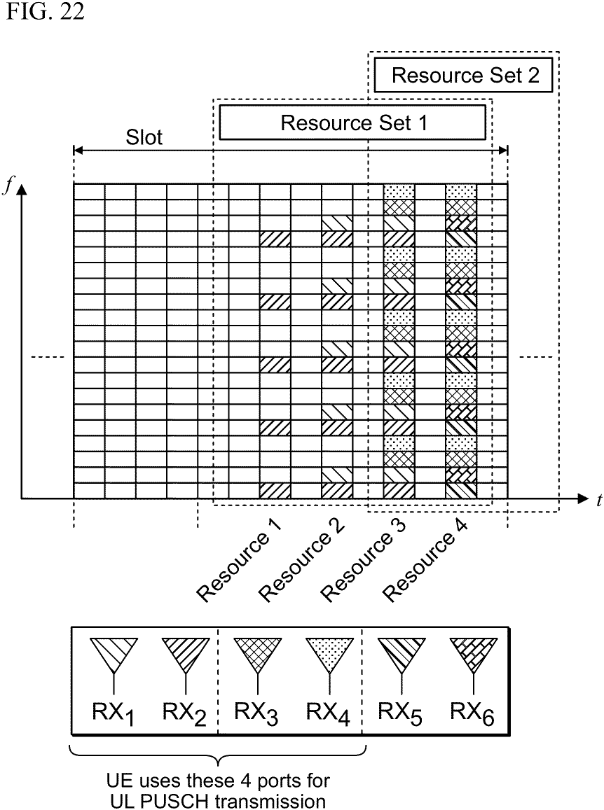

FIG. 20 shows a flow chart describing a sequence of steps. Those skilled in the art will appreciate that the steps described in FIG. 20 may be performed sequentially or in parallel and may not necessarily occur in the same order set forth in the flowchart. Similarly those skilled in the art will appreciate that steps may be repeated or omitted.

At step 1, the NW uses RRC configuration to configure two SRS resource sets (usage = ‘codebook’ and ‘antennaswitching’) with n overlapping resource. At step 2, using DCI, the NW triggers one or both of the SRS resource sets. At step 3, the UE transmits SRS resources associating each SRS port uniquely to an antenna port. At step 4, using SRI, the NW selects antenna port(s) associated with a particular SRS resource for UL PUSCH transmission.

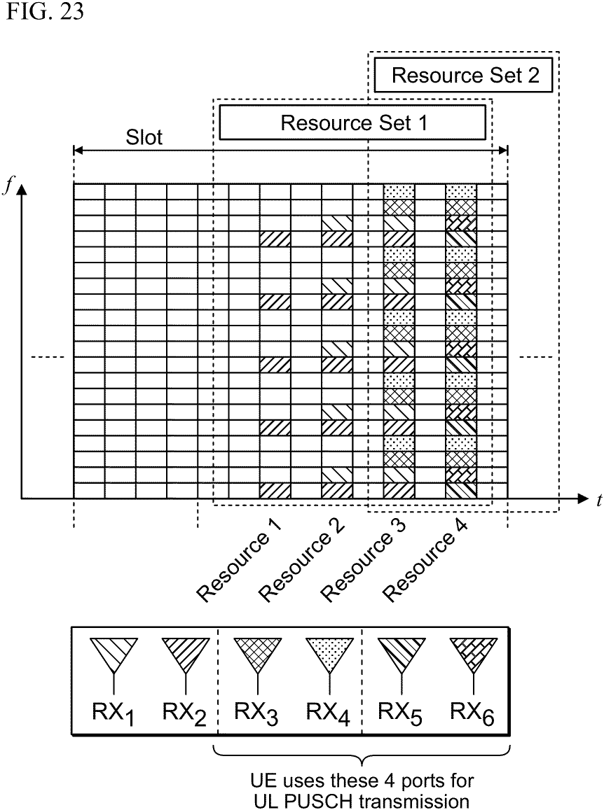

In Example 10, SRS Resource Set(s) Reuse for Different Usages for 4T4R are described with reference to FIG. 21. One or more embodiments in accordance with Example 10 may relate to a Rel. 16 UE operating in Mode 2. In one or more embodiments in accordance with Example 10, one SRS resource with 4 ports is higher layer configured to overlap between two SRS resource sets with usage set to ‘codebook’ and ‘antennaswitching,’ respectively. Using a SRS request field of DCI, the NW triggers either or both SRS resource sets with usage set to ‘codebook’ and ‘antennaswitching.’ In a case, if the NW indicates 4 port SRS resource using SRI, the 4 ports used for overlapping SRS resource transmission should be considered for UL PUSCH transmission as well.

In Example 10 described in FIG. 21, SRS resource 3 is configured overlapping between resource sets with usage ‘codebook’ and ‘antennaswitching.’ If the NW indicates 4 ports SRS resource 3 with SRI, the UE uses all 4 ports for UL PUSCH transmission. Further, in FIG. 21, resource set 1 usage is set to ‘codebook’ and resource set 2 usage is set to ‘antennaswitching.’ FIG. 21 also shows an example of a UE using all 4 ports for UL PUSCH transmission.

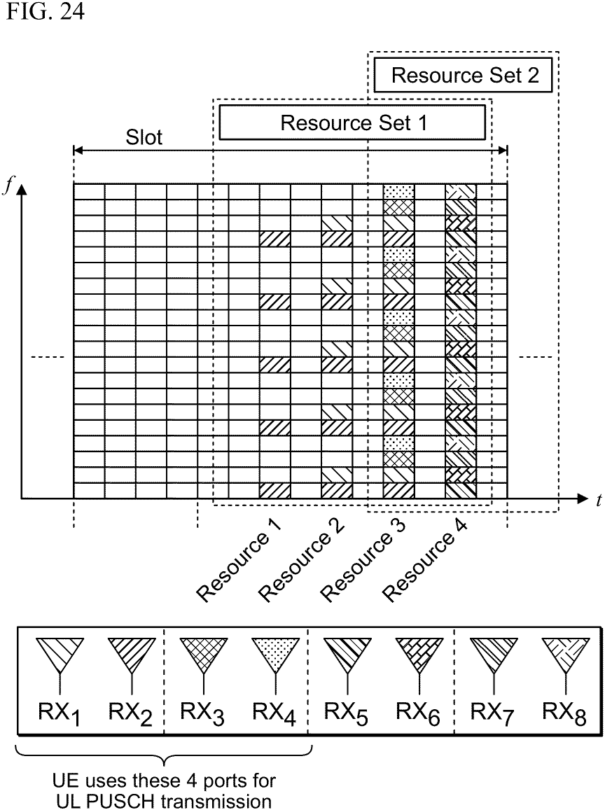

In Example 11, SRS Resource Set(s) Reuse for Different Usages for 4T6R are described with reference to FIG. 22. One or more embodiments in accordance with Example 11 may relate to a Rel. 16 UE operating in Mode 2. In one or more embodiments in accordance with Example 11, one SRS resource with 4 ports is higher layer configured to overlap between two SRS resource sets with usage set to ‘codebook’ and ‘antennaswitching,’ respectively. Using a SRS request field of DCI, the NW triggers either or both SRS resource sets with usage set to ‘codebook’ and ‘antennaswitching.’ In a case, if NW indicates 4 port SRS resource using SRI, the 4 ports used for overlapping SRS resource transmission should be considered for UL PUSCH transmission as well.

In Example 11 described in FIG. 22, SRS resource 3 is configured overlapping between resource sets with usage ‘codebook’ and ‘antennaswitching.’ If the NW indicates 4 ports SRS resource with SRI, the UE uses the same 4 ports used for SRS resource 3 transmission for UL PUSCH transmission. Further, in FIG. 22, resource set 1 usage is set to ‘codebook’ and resource set 2 usage is set to ‘antennaswitching.’ FIG. 22 also shows an example of a UE using 4 ports for UL PUSCH transmission.

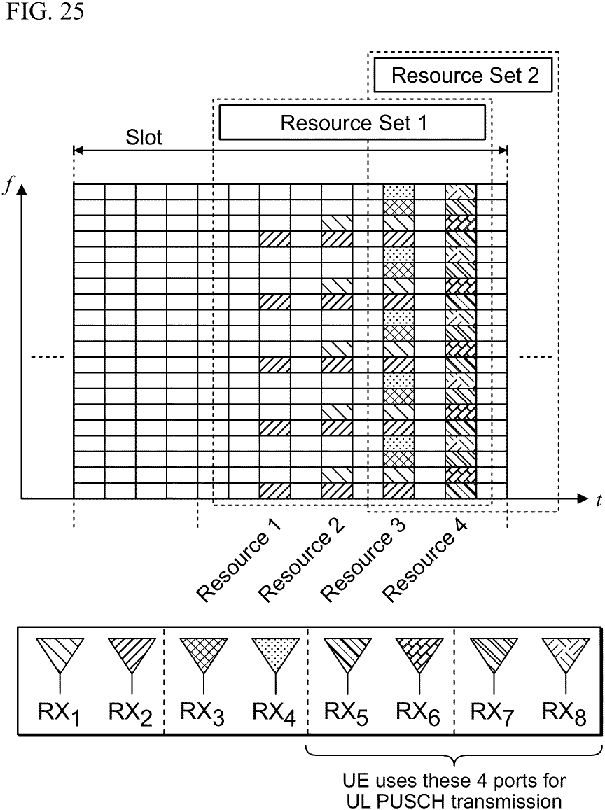

In Example 12, SRS Resource Set(s) Reuse for Different Usages for 4T6R are described with reference to FIG. 23. One or more embodiments in accordance with Example 12 may relate to a Rel. 16 UE operating in Mode 2. In one or more embodiments in accordance with Example 12, two SRS resources with 4 ports are higher layer configured to overlap between two SRS resource sets with usage set to ‘codebook’ and ‘antennaswitching,’ respectively. Using a SRS request field of DCI, the NW triggers either or both SRS resource sets with usage set to ‘codebook’ and ‘antennaswitching.’ In a case, if the NW indicates 4 port SRS resource using SRI, the 4 ports used for overlapping SRS resource transmission should be considered for UL PUSCH transmission as well.

In Example 12 described in FIG. 23, SRS resource 3 and 4 are configured overlapping between resource sets with usage ‘codebook’ and ‘antennaswitching.’ If the NW indicates 4 ports SRS resource 4 with SRI, the UE uses the same 4 ports used for SRS resource 4 transmission for UL PUSCH transmission. Further, in FIG. 23, resource set 1 usage is set to ‘codebook’ and resource set 2 usage is set to ‘antennaswitching.’ FIG. 23 also shows an example of a UE using 4 ports for UL PUSCH transmission.

In Example 13, SRS Resource Set(s) Reuse for Different Usages for 4T8R are described with reference to FIG. 24. One or more embodiments in accordance with Example 13 may relate to a Rel. 16 UE operating in Mode 2. In one or more embodiments in accordance with Example 13, one SRS resource with 4 ports is higher layer configured to overlap between two SRS resource sets with usage set to ‘codebook’ and ‘antennaswitching,’ respectively. Using a SRS request field of DCI, the NW triggers either or both SRS resource sets with usage set to ‘codebook’ and ‘antennaswitching.’ In a case, if the NW indicates 4 port SRS resource using SRI, the 4 ports used for shared resource transmission should be considered for UL PUSCH transmission as well.

In Example 13 described in FIG. 24, SRS resource 3 having 4 ports is reused for usage ‘codebook’ and ‘antennaswitching.’ If the NW indicates 4 ports SRS resource with SRI, the UE uses the same 4 ports used for SRS resource 3 transmission for UL PUSCH transmission. Further, in FIG. 24, resource set 1 usage is set to ‘codebook’ and resource set 2 usage is set to ‘antennaswitching.’ FIG. 24 also shows an example of a UE using 4 ports for UL PUSCH transmission.

In Example 14, SRS Resource Set(s) Reuse for Different Usages for 4T8R are described with reference to FIG. 25. One or more embodiments in accordance with Example 14 may relate to a Rel. 16 UE operating in Mode 2. In one or more embodiments in accordance with Example 14, two SRS resources with 4 ports are higher layer configured to share between two SRS resource sets with usage set to ‘codebook’ and ‘antennaswitching,’ respectively. Using a SRS request field of DCI, NW triggers either or both SRS resource sets with usage set to ‘codebook’ and ‘antennaswitching.’ In a case, if the NW indicates a 4 port SRS resource using SRI, the 4 ports used for transmitting indicated shared SRS resource should be considered for UL PUSCH transmission as well.

In Example 14 described in FIG. 25, SRS resource 3 and resource 4 having 4 ports are shared for usage ‘codebook’ and ‘antennaswitching.’ If the NW indicates 4 ports SRS resource 4 with SRI, the UE uses the same 4 ports used for transmitting SRS resource 4 for UL PUSCH transmission. Further, in FIG. 25, resource set 1 usage is set to ‘codebook’ and resource set 2 usage is set to ‘antennaswitching.’ FIG. 25 also shows an example of a UE using 4 ports for UL PUSCH transmission.

In Example 15, one or more embodiments of SRS Resource/Resource Set Configuration are described. Currently, TS 38.214 allows to configure only last 6 symbols of the slot for SRS stating: “The UE may be configured by the higher layer parameter resourceMapping in SRS-Resource with an SRS resource occupying Nₛ ∈ {1,2,4} adjacent symbols within the last 6 symbols of the slot, where all antenna ports of the SRS resources are mapped to each symbol of the resource.” However, this needs to be updated as follows to configure any symbol of the slot for SRS transmission: “The UE may be configured by the higher layer parameter resourceMapping in SRS-Resource with an SRS resource occupying Nₛ ∈ {1,2,4, 6, 8, 12} adjacent symbols anywhere within the slot, where all antenna ports of the SRS resources are mapped to each symbol of the resource.”

In one or more embodiments in accordance with any or all of examples 1 through 14, SRS resource set(s) associated with a particular usage, i.e. ‘codebook’ or ‘antennaswitching,’ can be configured with resourceType ‘periodic’ or ‘semi-persistent’ while the other SRS resource set can be configured ‘aperiodic.’

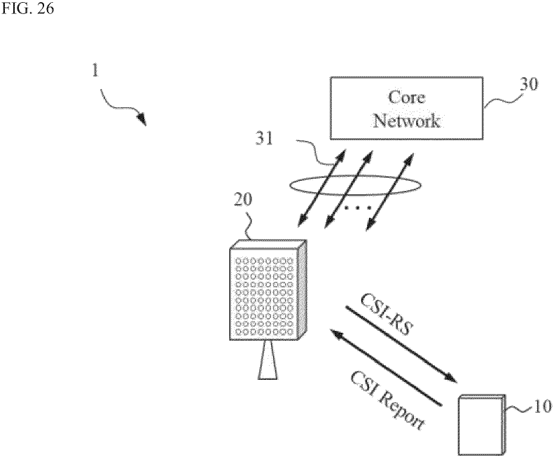

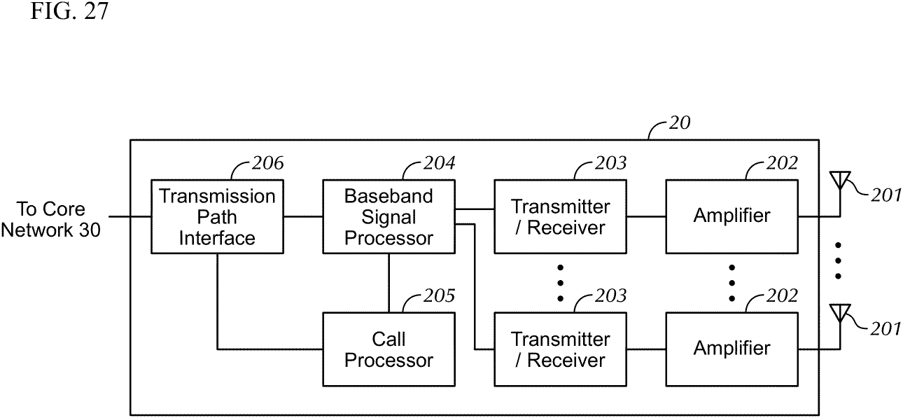

FIG. 26 is a wireless communications system 1 according to one or more embodiments of the present invention. The wireless communication system 1 includes a user equipment (UE) 10, a base station (BS) 20, and a core network 30. The wireless communication system 1 may be a NR system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be gNodeB (gNB). The BS 20 may be referred to as a network (NW) 20.

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

As shown in FIG. 26, the BS 20 may transmit a CSI-Reference Signal (CSI-RS) to the UE 10. In response, the UE 10 may transmit a CSI report to the BS 20. Similarly, the UE 10 may transmit SRS to the BS 20.

### Configuration of BS

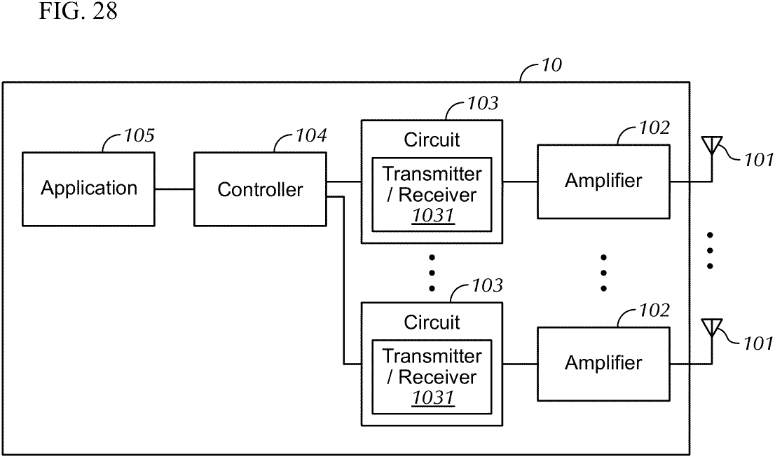

The BS 20 according to embodiments of the present invention will be described below with reference to FIG. 27. FIG. 27 is a diagram illustrating a schematic configuration of the BS 20 according to embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network through the transmission path interface 206. The call processor 205 performs call processing such as setting up and releasing a communication channel, manages the state of the BS 20, and manages the radio resources.

### Configuration of UE

The UE 10 according to embodiments of the present invention will be described below with reference to FIG. 28. FIG. 28 is a schematic configuration of the UE 10 according to embodiments of the present invention. The UE 10 has a plurality of UE antenna S101, amplifiers 102, the circuit 103 comprising transceiver (transmitter/receiver) 1031, the controller 104, and an application 105.

As for DL, radio frequency signals received in the UE antenna S101 are amplified in the respective amplifiers 102, and subj ected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

### Another Example

The above examples and modified examples may be combined with each other, and various features of these examples may be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A user equipment (UE), comprising:
a receiver that receives a parameter;
a processer that, based on the parameter, configures Sounding Reference Signal (SRS) resources with a first SRS resource set and a second SRS resource set; and
a transmitter that transmits one or more SRSs using the SRS resources.

2. The UE according to claim 1,
wherein the first SRS resource set has a first usage and the second SRS resource set has a second usage, and
wherein the first SRS resource set and the second SRS resource set overlap.

3. The UE according to claim 1, wherein the parameter indicates at least one of ‘codebook’ and ‘antennaswitching’.

4. The UE according to claim 1, wherein each of the first SRS resource set and the second SRS resource set has one of 1, 2, and 4 antenna ports.

5. The UE according to claim 1, wherein the receiver receives downlink control information (DCI) triggering usage of at least one of the first SRS resource set and the second SRS resource set.

6. The UE according to claim 1, wherein each of the SRS resources has a unique antenna port.

7. The UE according to claim 1, wherein the parameter indicates a number n of overlapping SRS resources between the first SRS resource set and the second SRS resource set.

8. The UE according to claim 1, wherein each of the SRS resources has a unique antenna port.

9. The UE according to claim 1, wherein the transmitter transmits a first SRS using a SRS resource from the first SRS resource set and a second SRS using a second SRS resource from the second SRS resource set, and wherein the first SRS and the second SRS are associated to an antenna port pair.

10. The UE according to claim 1, wherein the receiver receives a resource indicator by downlink control information indicating an antenna port for Physical Uplink Shared Channel (PUSCH) transmission.

11. The UE according to claim 1, wherein the parameter is higher layer signaled.

12. A method for a user equipment (UE), comprising:
receiving a parameter;
configuring, based on the parameter, Sounding Reference Signal (SRS) resources with a first SRS resource set and a second SRS resource set; and
transmitting one or more SRSs using the SRS resources.

13. A wireless communication system, comprising:
a user equipment (UE), comprising:
a receiver that receives a parameter;
a processer that, based on the parameter, configures Sounding Reference Signal (SRS) resources with a first SRS resource set and a second SRS resource set; and
a transmitter that transmits one or more SRSs using the SRS resources; and
a base station (BS), comprising:
a second receiver that receives the one or more SRSs.

14. The UE according to claim 2, wherein the parameter indicates at least one of ‘codebook’ and ‘antennaswitching’.

15. The UE according to claim 2, wherein each of the first SRS resource set and the second SRS resource set has one of 1, 2, and 4 antenna ports.

16. The UE according to claim 3, wherein each of the first SRS resource set and the second SRS resource set has one of 1, 2, and 4 antenna ports.

17. The UE according to claim 2, wherein the receiver receives downlink control information (DCI) triggering usage of at least one of the first SRS resource set and the second SRS resource set.

18. The UE according to claim 3, wherein the receiver receives downlink control information (DCI) triggering usage of at least one of the first SRS resource set and the second SRS resource set.

19. The UE according to claim 4, wherein the receiver receives downlink control information (DCI) triggering usage of at least one of the first SRS resource set and the second SRS resource set.

20. The UE according to claim 2, wherein each of the SRS resources has a unique antenna port.
